(19) United States
(12) Patent Application Publication
(10) Pub. No.: US 2008/0256132 A1
(43) Pub. Date: Oct. 16, 2008

(54) Method and system for determining incident impact

(75) Inventors: Jillian Paige Munro, Maplewood, NJ (US); Patrick Anthony Alesi, Howard Beach, NY (US); Michael Engle, South Amboy, NJ (US)

Correspondence Address: MORGAN, LEWIS & BOCKIUS LLP, 1701 MARKET STREET, PHILADELPHIA, PA, 19103-2921, US

(73) Assignee: Lehman Brothers Inc., New York, NY (US)

(21) Appl. No.: 12/082,560

(22) Filed: Apr. 11, 2008

Related U.S. Application Data
(60) Provisional application No. 60/922,825, filed on Apr. 11, 2007.

(51) Int. Cl. G06F 17/30

(52) U.S. Cl. 707/104.1; 707/E17.044

(57) ABSTRACT

A method and system for determining an impact of an incident. An occurrence of an incident is identified. One or more persons at least potentially impacted by the incident are identified based on dynamic indications. After the occurrence, one or more indicators associated with the one or more persons identified are detected. Based on the indicators, the extent to which the persons identified have been impacted by the incident is assessed.

### FIELD OF THE INVENTION

The present invention relates to systems and methods for determining the impact of an incident.

### BACKGROUND OF THE INVENTION

It is becoming increasingly important for entities, large and small, to account for their employees upon the occurrence of an incident, such as a man-made or natural disaster. Of additional importance is to be able to assess, in the most accurate manner possible, the extent to which employees have been impacted by the incident to allow for targeted accounting and recovery efforts.

### SUMMARY OF THE INVENTION

The present invention is directed to a method and system for determining an impact of an incident. An occurrence of an incident is identified. One or more persons at least potentially impacted by the incident are identified based on dynamic indications. After the occurrence, one or more indicators associated with the one or more persons identified are detected. Based on the indicators, the extent to which the persons identified have been impacted by the incident is assessed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 depicts an exemplary architecture that may be used in connection with implementing the present invention;

FIG. 2 is an exemplary user interface that may be used in accordance with the present invention;

FIG. 3 is an exemplary user interface that may be used in accordance with the present invention;

FIG. 4 is an exemplary report that may be generated in accordance with the present invention;

FIG. 5 is an exemplary report that may be generated in accordance with the present invention; and

FIG. 6 is a flow chart illustrating a preferred embodiment of a method of the present invention.

### DETAILED DESCRIPTION OF THE PREFERRED EMBODIMENTS

The system and method described herein allow a user to define an incident, dynamically build a list of people potentially impacted based on characteristics of the incident, and detect indicators relating to the individuals in the impacted list to assess the extent to which such individuals have been affected by the incident. This gives entities the ability to identify the population of people who may be immediately impacted by an incident (e.g., a natural disaster such as a fire, or a man-made disaster such as a bombing or chemical attack) and a tool with which to prioritize and track the accounting process. It supports a mobile workforce by dynamically building the list of people potentially impacted based on a person's activity and whereabouts leading up to an incident, thereby eliminating the need to rely solely on a person's primary work location. Further, it provides a way to target accounting and recovery efforts on people from whom there has been no sign indicating such individuals are safe.

The incident can be defined in terms of when it incident started, where it occurred, the type of incident, and whether it is connected to any other incident. Incidents start and eventually end, although they can be of varied duration. Some information that defines the incident is merely descriptive of the incident, while other information that defines the incident may be used to identify individuals who are listed on the potentially impacted list. The incident definition drives creation of the persons impacted list.

Based on the incident definition, a list of individuals who may be impacted by the incident is created, based on what is believed to be the whereabouts of an individual in view of the individual's activity over the days leading up to the incident. In order to accomplish this, the system maintains a current view of an individual's predominant site, as well as his or her last identified site. The predominant site is based on a person's movement over the previous X number of days (this value X is configurable, but typically on the order of 3 days in the preferred embodiment). The types of indicators used for such detection may include building access information and cellular (mobile phone or mobile electronic mail, e.g., blackberry) activity, if accessible. If an individual is not within the geographic area of the incident within the defined period leading up to the incident, he or she will not appear on the persons impacted list, regardless of his or her primary work location, in the preferred embodiment.

The system may also take into account longer-term pandemic types of incidents to generate the potentially impacted list based on more static data elements such as an individual's primary work location or home.

Indicators represent bits of information the system uses to determine whether there has been some activity from an individual after the inception of an incident. These indicators use a level of confidence weighting to provide an assessment as to whether or not the system can consider the person active. Types of indicators include, but are not limited to the building access activity, mobile phone activity, mobile electronic mail, e.g., blackberry activity, and/or remote login.

Beyond the dynamically generated indicator assessments, during an incident, there are many cases of observed status on a person. The system provides a method to capture such information on a given individual and feed that into the overall recovery status assessment. To enter an observation note, a user is required to identify the person, enter a brief comment, specify where they believe the person to be (e.g., on vacation, at home, in office, etc.), and whether they believe the person is mobility impaired as a result of the incident, safe, at risk, or an attempt has been made to contact the person with no reply. Records are kept on who has provided such an accounting and when the observation was reported.

For each individual on the persons impacted list, the system interprets the indicators to arrive at a summary assessment of each person's recovery status. A positive hit on one or more high confidence indicators will yield a summary status of “yes”—meaning that the system has detected enough activity on this person after the start of the incident to make the determination that they are alive and responding.

The system provides a summary view of each incident by totaling up the number of people determined safe through indicators as well as the number of people by status reported through observed notes.

For each incident, there are detailed views of indicator and observation information for each person on the persons impacted list. These views may include, but are not limited to most recent time a person swiped their building access card; most recent time their cellular device was contacted; most recent time an email was sent from a cellular device (e.g., blackberry); most recent time a remote connection was made.

In addition, the system provides more discrete views that are a subset of the persons impacted list to be used by various recovery constituents (e.g., by building or by division).

Thus, the following activities may be undertaken using the system described herein:
Create an incident
Update an incident
View results by building
View results by division
Create a manual observation note for a person

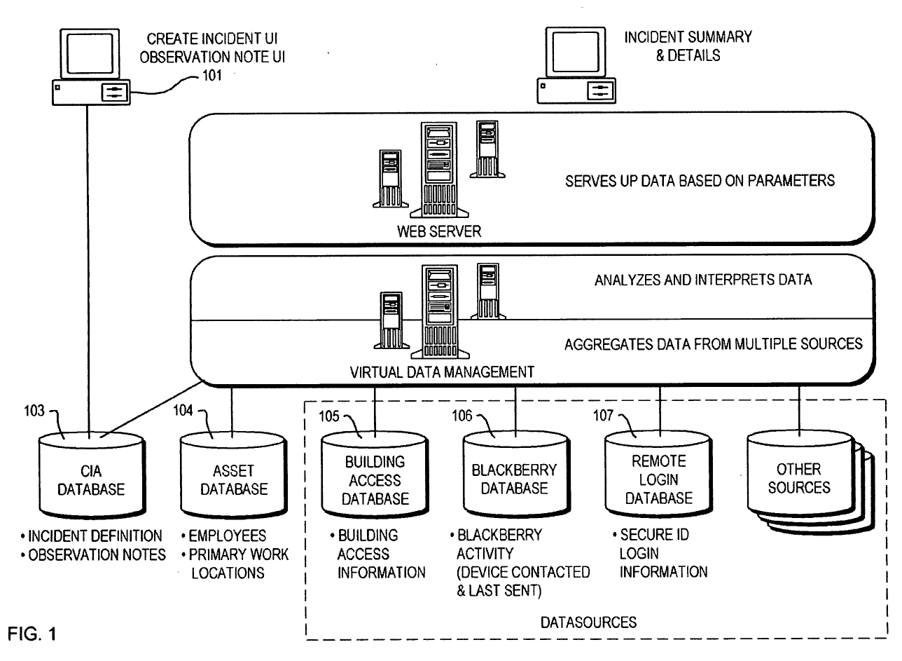

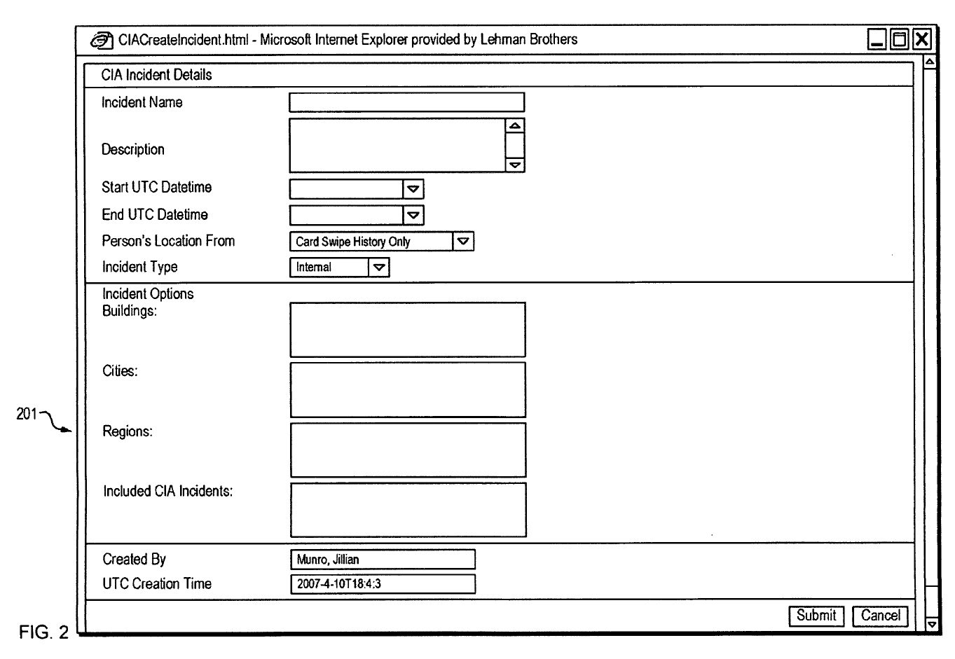

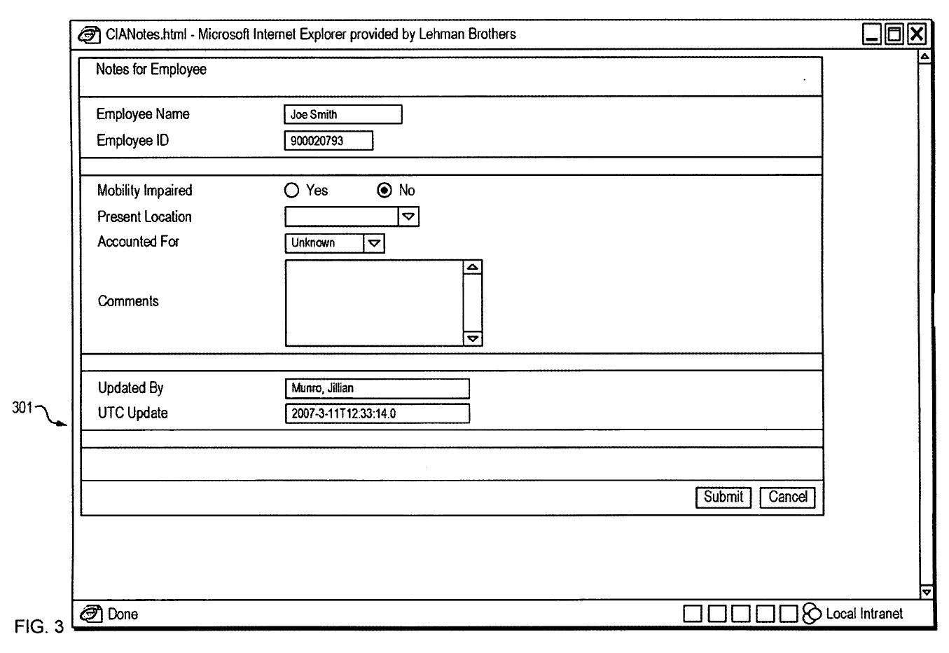

FIG. 1 shows an exemplary architecture that may be used to implement the present invention. User station 101 may be used to create an incident or observation note, using exemplary interfaces 201 and 301 of FIGS. 2 and 3, respectively. User station 102 may be used to view incident summaries and details. Database 103 is used to store the incident definition and observation notes. Database 104 is used to store information regarding employees, such as their primary work locations. Databases 105, 106, 107 and 108 may serve as datasources for indicators. For example, such database may store data regarding building access, mobile electronic mail, e.g., blackberry activity, and remote login information.

FIG. 2 is an exemplary user interface depicting an Incident Screen 201 which may be used for defining, viewing, and updating information about an incident.

FIG. 3 is an exemplary interface depicting an Observation Notes Screen 301 that may be used to provide observation notes about an individual.

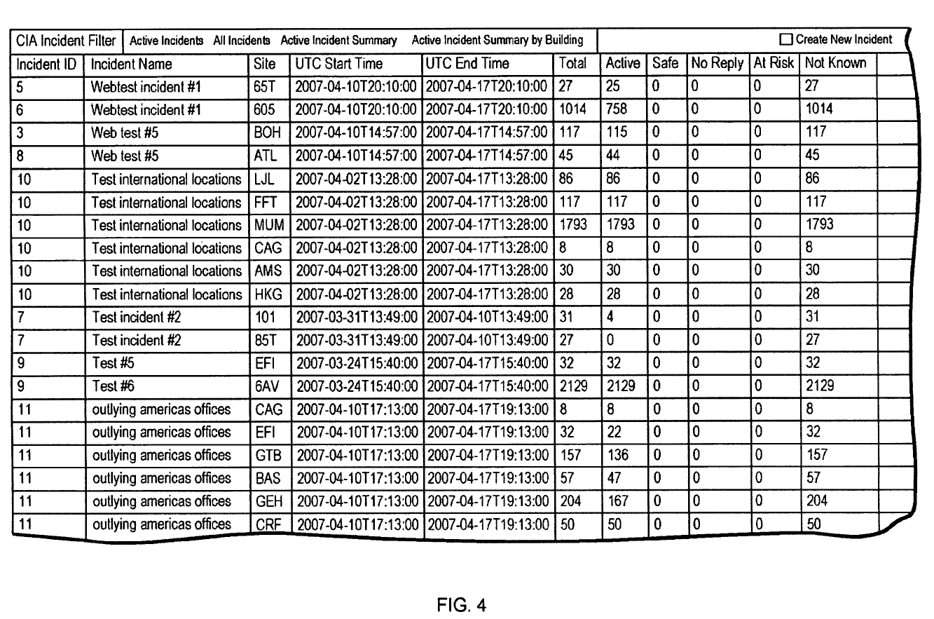

FIG. 4 shows an exemplary Incident Summary report. This provides a summary view of the total number of people potentially impacted by the incident, the number for whom the system has detected an indicator, and the total number of people for whom an observation note has been created.

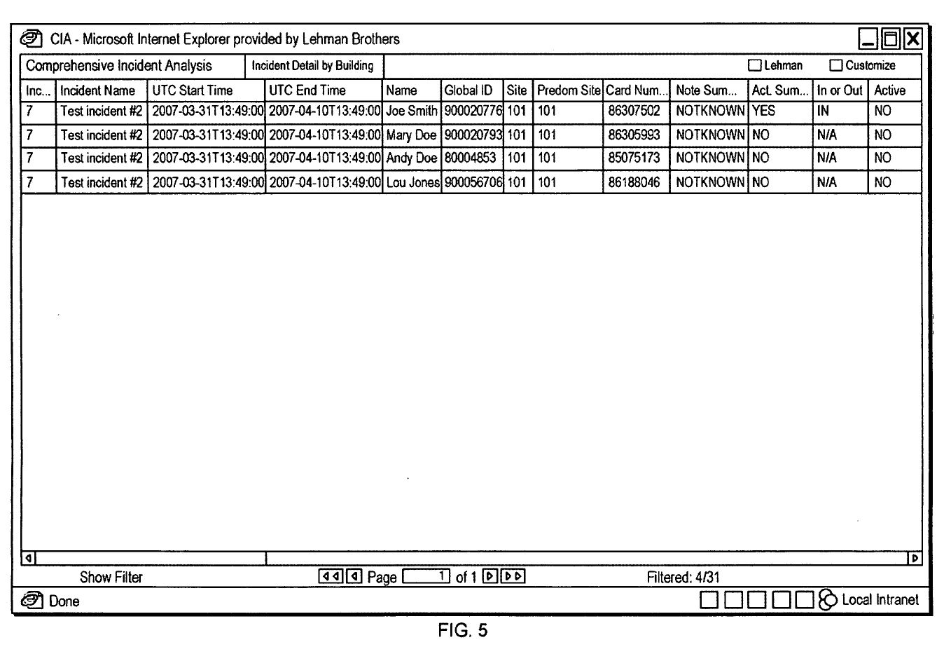

FIG. 5 depicts an exemplary report showing incident details,

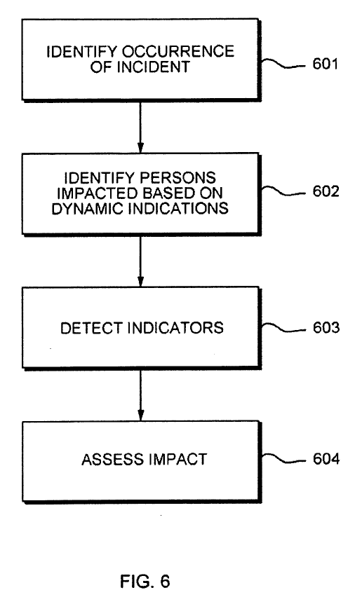

FIG. 6 is a flow chart illustrating an exemplary method of the present invention for determining an impact of an incident. In step 601, an occurrence of an incident is identified. In step 602, one or more persons at least potentially impacted by the incident are identified based on dynamic indications, in step 603, after the occurrence, one or more indicators associated with the one or more persons identified are detected. In step 604, the extent to which the one or more persons identified have been impacted by the incident is assessed based on the indicators.

What is claimed is:

1. A method for determining an impact of an incident, comprising:
identifying an occurrence of an incident;
identifying one or more persons at least potentially impacted by the incident based on one or more dynamic indications;
after the occurrence, detecting one or more indicators associated with the one or more persons identified;
based on one or more of the one or more indicators, assessing the extent to which the one or more persons identified have been impacted by the incident.

2. The method of claim 1 wherein the one or more dynamic indications comprise activity by one or more of the one or more persons during a time period associated with the occurrence and in a location associated with the occurrence.

3. The method of claim 1, wherein identifying the one or more persons at least potentially impacted by the incident is based further on one or more static data elements.

4. The method of claim 3 wherein the one or more static elements comprise one or more of a primary work location of one or more of the one or more persons and a home of one or more of the one or more persons.

5. The method of claim 1 wherein the one or more indicators comprise at least one of: building access activity, mobile phone activity, mobile electronic mail activity and remote login activity.

6. The method of claim 1 wherein assessing the extent to which the one or more persons identified have been impacted by the incident is based further on observation notes relating to the one or more persons.

7. A computer-readable medium comprising instructions which, when executed by a processor cause the processor to perform a method for determining an impact of an incident the method comprising:
identifying an occurrence of an incident;
identifying one or more persons at least potentially impacted by the incident based on one or more dynamic indications;
after the occurrence, detecting one or more indicators associated with the one or more persons identified;
based on one or more of the one or more indicators, assessing the extent to which the one or more persons identified have been impacted by the incident.

8. The computer-readable medium of claim 7 wherein the one or more dynamic indications comprise activity by one or more of the one or more persons during a time period associated with the occurrence and in a location associated with the occurrence.

9. The computer-readable medium of claim 7, wherein identifying the one or more persons at least potentially impacted by the incident is based further on one or more static data elements.

10. The computer-readable medium of claim 9 wherein the one or more static elements comprise one or more of a primary work location of one or more of the one or more persons and a home of one or more of the one or more persons.

11. The computer-readable medium of claim 7 wherein the one or more indicators comprise at least one of: building access activity, mobile phone activity, mobile electronic mail activity and remote login activity.

12. The computer-readable medium of claim 7 wherein assessing the extent to which the one or more persons identified have been impacted by the incident is based further on observation notes relating to the one or more persons.

13. A system for determining an impact of an incident, the method comprising:
one or more databases that store incident information identifying an occurrence of an incident, and
a processor that:
identifies one or more persons at least potentially impacted by the incident based on one or more dynamic indications;
after the occurrence, detects one or more indicators associated with the one or more persons identified; and
based on one or more of the one or more indicators, assesses the extent to which the one or more persons identified have been impacted by the incident.

14. The system of claim 13 wherein the one or more dynamic indications comprise activity by one or more of the one or more persons during a time period associated with the occurrence and in a location associated with the occurrence.

15. The system of claim 13 wherein identifying the one or more persons at least potentially impacted by the incident is based further on one or more static data elements.

16. The system of claim 15 wherein the one or more static elements comprise one or more of a primary work location of one or more of the one or more persons and a home of one or more of the one or more persons.

17. The system of claim 15 wherein the one or more indicators comprise at least one of: building access activity, mobile phone activity, mobile electronic mail activity and remote login activity.

18. The system of claim 15 wherein assessing the extent to which the one or more persons identified have been impacted by the incident is based further on observation notes relating to the one or more persons.
